(19) United States
(12) Patent Application Publication
(10) Pub. No.: US 2022/0309437 A1
(43) Pub. Date: Sep. 29, 2022

(54) AUTOMATED SYSTEM AND METHOD FOR AUTHORING QUALITY MANAGEMENT DOCUMENTS AND MANAGING REGULATORY REQUIREMENTS

(71) Applicant: CrucialQ ehf., Hafnarfjordur (IS)

(72) Inventors: Gudmundur SAEVARSSON, Hafnarfjordur (IS); Omar HILMARSSON, Hafnarfjordur (IS)

(21) Appl. No.: 17/703,196

(22) Filed: Mar. 24, 2022

Related U.S. Application Data
(60) Provisional application No. 63/165,311, filed on Mar. 24, 2021.

(51) Int. Cl. G06Q 10/06; G06F 40/186; G06F 16/93

(52) U.S. Cl. CPC G06Q 10/06395; G06Q 10/0633; G06F 40/186; G06F 16/93

(57) ABSTRACT

An automated system and method for authoring quality management documents and managing regulatory requirements include converting relevant parts of regulatory requirements, written in a language only humans can understand, to a specifically designed domain-specific language that encapsulates the legal meaning in such a way in it can be interpreted by one or more processors. The system may allow users to create Quality Manuals and associated Process Documents in a modular way from applicable regulatory requirements. The automated system and method may track compliance with a regulatory requirement using the at least one document by guiding users through at least one workflow defined in the document and/or training users.

### TECHNICAL FIELD

The disclosure relates to an automated system and method for authoring quality management documents and managing requirements in regulated fields.

### BACKGROUND

In fields with significant importance for human health, safety, and well-being, such as medical device manufacturing, pharmaceuticals, aviation, education, energy development, banking, broadcasting, agriculture, water resources, automobiles, infrastructure, food safety, mineral, and resource development, telecommunication, and others, governmental regulations are passed and enforced for consumer and patient benefit.

Governmental regulations, often enacted and enforced by agencies, such as, in the United States, the Food and Drug Administration (FDA), the Securities and Exchange Commission (SEC), the Federal Communications Commission (FCC), the Federal Aviation Administration (FAA), and the Environmental Protection Agency (EPA), or in Europe, the European Medicines Agency (EMA), and the European Commission, while beneficial for consumers and patients, often present unique challenges for firms seeking to enter or introduce a product or service in the marketplace.

For example, the process for acquiring regulatory approval to introduce a new medical device in the United States is highly involved, requiring that a medical device manufacturer pass steps including Establishment Registration, Medical Device Listing, Premarket Notification 510(k) or Premarket Approval, Investigational Device Exemption (IDE) for clinical studies, Quality System Regulation, Labeling requirements, and Medical Device Reporting. These requirements are set forth in 21 C.F.R. Part 807, 21 C.F.R. Part 814, 21 C.F.R. Part 812, 21 C.F.R. Part 820, 21 C.F.R. Part 801, and 21 C.F.R. Part 803, respectively.

Regulations set forth in the legal codes above describe what needs to be adhered to, and individual firms, such as manufacturers of regulated devices, must determine which subset of requirements from said regulations are applicable to them and how to adhere to them. To adhere to the relevant regulations, a medical device manufacturer must determine the applicable regulation, author therefrom a Quality Manual and Processes, and conduct said Processes in a provable way. The Quality Manual is an overview document referencing all relevant processes for how the manufacturer or firm will adhere to the pertinent requirements, the Processes include instructions on what needs to be performed and by whom.

Authoring a Quality Manual and Processes is labor intensive, costly, and a difficult process even for established medical device manufacturers. The process of authoring requires the individual authoring the Quality Manual to have access to knowledge regarding, in the first instance, which regulations generally apply to the manufacturer and are pertinent to a particular device. Further, the manufacturer must determine which requirements of the relevant regulations are pertinent.

The requirements of each regulation are a function of which market the manufacturers are operating in and what type of device they are manufacturing, which varies significantly between and within manufacturers. Upon determining which requirements are pertinent, a manufacturer must create processes which, if properly followed, will ensure that the correct requirements will all be fulfilled.

Manufacturers tend to emulate industry-accepted best practices when authoring the processes, as any innovative alternative approach to a process must be explained to pertinent regulatory authorities so as to validate that the innovative approach is valid and as effective as the industry-accepted best practices.

The process of authoring a Quality Manual is necessarily conducted by a manufacturer to obtain an initial Quality Manual and associated Processes. The authoring process must often be repeated when regulations change or when the manufacturer begins offering different products that trigger additional requirements that they must adhere to.

Ordinarily, manufacturers commission employees and/or consultants to investigate which regulations and requirements apply to the manufacturer and the particular product or device, determined as a function of the type of device or product and the market in which the device or product will be sold, and to author a Quality Manual and processes therefrom. The Quality Manual and processes comprise a set of documents, the Quality Manual being a reference document to the processes. The majority of the work is often performed for and contained in the processes.

An alternative to the authoring process is purchasing a commercially available Quality Manual specific to the manufacturer's field, such as the medical device market. Commercially available Quality Manuals tend to be tailored to one or more of the most prominent regulations. In the field of medical devices, a commercially available Quality Manual may pertain to one or both of 21 C.F.R. 820 (the FDA regulations for the US market) or MDR (a new regulation for the EU market).

Commercially available Quality Manuals are often structured so as to cover all requirements of a particular regulatory environment, and require the manufacturer to edit the Quality Manual and remove all sections that are not applicable to them. Even after purchasing and appropriately editing the commercially available Quality Manual, manufacturers still have to write their associated Process Documents and ensure that they are correctly referenced in the Quality Manual.

While efforts have been made to provide a software-based solution for authoring Quality Manuals, these still require a manufacturer or user to manually author the associated process documents from the pertinent regulatory standards. For example, the software-based solution may provide a questionnaire for the manufacturer or user from the responses to which the software generates a Quality Manual. The manufacturer or user must then create the process documents and provide reference names to the processes in the Quality Manual. Each of these steps must be repeated each a time a new regulation is passed or an existing regulation is updated.

While certain software-based solutions attempt to provide a gap analysis for the manufacturer, this analysis simply lists processes required by the Quality Manual for which the manufacturer or user could not provide process references.

After producing a Quality Manual and associated processes, most manufacturers still use a paper-based method for running the processes. This includes the necessarily manual steps of training employees using the relevant process documents, relying on the employees to properly execute process steps and to fill out and sign output documents that serve as proof of their work, conducting periodic reviews that ensure the processes are being adhered to, and taking corrective action if nonconformity in the employees' execution of the processes is identified from the periodic reviews.

In such a paper-based method, the process documents are sacrosanct, and employees must be trained in the processes that are relevant to their role. The manual execution of processes relies on employees using the process documents as inputs and signing output documents to provide a reviewable record that can be assessed to determine whether the processes have been correctly adhered to. If, during a periodic review, it is determined that a particular process has not been adhered to correctly, a process for corrective action will be triggered. Often this corrective action is re-training the employees.

An Electronic Quality Management System (eQMS) is an existing approach for guiding employees through regulatory requirements, particularly using user-defined workflows. eQMS software packages rely on each manufacturer to define custom workflows within the eQMS software to match the text descriptions of pertinent process documents, which is a complex and time-consuming process that must be thoroughly validated to ensure that the eQMS workflow actually matches the intent of the process documentation. Because the eQMS software does not understand the processes, training materials need to be defined and added to the eQMS software, which not all eQMS software packages support.

While existing eQMS software packages are configured to allow specificity regarding a workflow corresponding to a process, they are poorly adapted to describing the interdependencies between distinct processes, and a manual periodic review is still required to ensure that processes are being adhered to.

In view of the foregoing, there is a need for an automated system for authoring and managing requirements in regulated fields that addresses the problems of the art, such as the cost and difficulty of authoring Quality Manuals and associated process documents for each manufacturer and for particular products. There is further a need for an automated system for authoring and managing requirements in regulated fields that can be automated such that the system may be adapted to any suitable field and any suitable regulation. There is further a need for an automated system that allows for implementing and monitoring workflows derived from associated process documents.

### SUMMARY

The drawbacks of existing approaches to authoring quality manuals and related processes are addressed by embodiments of an automated system and method for authoring quality management documents and managing regulatory requirements. The automated system and method embodiments provide for both the relevant regulatory standards and regulatory processes such that the automated system retrieves information from a manufacturer or user to author one or both of a Quality Manual and accompanying Process Documents. The automated system embodiments thus advantageously reduce the cost, complexity, and time-intensity of authoring custom Quality Manuals and/or Process Documents pertaining to a particular product and/or market.

In embodiments of the automated system for authoring quality management documents and managing regulatory requirements, one or both of the Quality Manual and the accompanying Process Documents are stored in the automated system, such as in a storage device, in a domain-specific language (DSL), which will be described in greater detail below. The DSL is formulated to contain enough information to give the automated system the understanding needed to ensure that the processes are being adhered to. The automated system is configured to automatically author a Quality Manual and related Processes, including Process Documents, from the DSL.

The automated system embodiments advantageously may be configured to automatically author Quality Manuals and Process Documents including built-in standards and processes directly from regulatory documents, store the standards and processes in a DSL so as to be understood by one or more software components, and run the processes using the system to ascertain whether the processes are being adhered to.

To author the Quality Manual and the Process Documents, an automated system, in which the relevant standards and processes for a particular field, such as medical devices, are stored in a storage device, provides a questionnaire to a manufacturer or user regarding the product or market of interest. The answers provided by the manufacturer or user are used to author a custom Quality Manual and relevant processes, which are stored on the automated system in the DSL. The DSL is suitable for the Quality Manual and the relevant processes to be automatically output as readable documents.

The automated system according to embodiments advantageously provides an improved workflow and facilitates training of employees as required. The automated system may provide or utilize an improved eQMS configured to receive the Quality Manual and Process Documents automatically generated previously by the system. This advantageously mitigates the need to convert human-readable Process Documents to eQMS workflows, as the workflow information is already stored in the DSL format.

The automated system further is configured to trace how a particular requirement in a particular regulation maps to a process or one or more steps in a process, as the automated system is configured to account for not only the process itself but also the relationship between different processes. The automated system is configured to automate the training for each employee in any particular role. The system may detect that a user is executing a process for the first time without training and can run the user through the required training by having the user execute the pertinent workflow using mock or sample data and then signing a training report.

The automated system is configured to perform any regulation-required reviews, with the advantage that a reviewer can ascertain that the process under review was executed in the correct order by the correct employees. Thus the reviewer needs only to determine whether they agree with the content provided by the pertinent employees, such as a review of a hazard analysis where the reviewer does not agree with the risk assessment provided by an employee for a particular feature.

By providing an automated system according to the disclosed embodiments, the drawbacks, including the cost, complexity, and time-intensity of existing approaches to authoring quality management documents and managing regulatory documents, are addressed. The automated system embodiments advantageously provide a DSL allowing a manufacturer or user to generate a custom Quality Manual and associated Process Documents directly from pertinent regulatory and statutory documents and to more easily track compliance therewith.

### Glossary

The terms set forth below will have the meaning as defined:

“compiler” means a program that determines whether there are errors in the code. The compiler may be any suitable compiler, such as a cross-compiler, a bootstrap compiler, a decompiler, a transcompiler, a one-pass or multi-pass compiler, or otherwise;

“domain-specific language” OR “DSL” means a computer language specialized to a particular application domain. The DSL may be a computer language specialized to the domain of storing regulatory requirements such that the legal meaning of said regulatory requirements can be understood and applied by a specialized computer;

“domain-specific language code” OR “DSL code” means computer-readable and executable code of one or more requirements of one or more regulations described in the regulatory documents that have been translated into the domain-specific language;

“graphical user interface” or “GUI” means a graphics-based user interface with images, words, signs, and/or figures that is displayed to a user on a screen or display that incorporates interactive windows and icons;

“operator” means an organization associated with regulatory requirements and may include manufacturers, authorized representatives, importers, notified bodies, and the like;

“Process Documents” are documents that outline regulated processes and describe how to comply with regulatory requirements;

“processor” means an electrical component of hardware and/or software that performs required functions. Exemplary processors include microprocessors, central processing unit (CPU) devices, computing devices, microcontrollers, digital signal processors or like devices;

“Quality Manual” means a document that describes the quality management system of an organization;

“regulatory requirements” means defined standards in a suitable field, such as a field regulated by one or more government agencies, trade associations, or other organizations, in such fields as medical devices, in-vitro diagnostics, pharmaceutical research, aviation, banking and finance, environmental protection, and others;

“storage” or “storage device” means a recording medium readable by a computer processor capable of storing data;

“user interface” means an interface between a user and the automated system or component of the automated system that enables communication between the user and the automated system or component of the automated system;

“user” means a person who uses the automated system for authoring quality management documents and managing regulatory requirements. A user may be an employee, employer, operator, manager, or another individual with a specified role; and

“workflow” means a scheme for managing corresponding tasks and processes that instructs users and organizations in accomplishing regulated work.

### BRIEF DESCRIPTION OF THE DRAWINGS

These and other features, aspects, and advantages of the present disclosure will become better understood regarding the following description, appended claims, and accompanying drawings.

FIG. 1 is a flowchart of an existing approach to authoring quality management documents.

FIG. 2 is a flowchart of an existing method for authoring quality management documents according to the approach of FIG. 1.

FIG. 3 is a flowchart of an existing method for authoring quality management documents according to another method.

FIG. 4 is a flowchart of an existing method for authoring quality management documents according to another method.

FIG. 5 is a flowchart of a method of assessing compliance with regulatory processes according to an existing method.

FIG. 6 is a flowchart of a method of assessing compliance with regulatory processes according to another existing method.

FIG. 7 is a flowchart of a method of automatically authoring quality management documents according to an embodiment of the present disclosure.

FIG. 8 is a flowchart of a method of assessing compliance with regulatory processes according to an embodiment of the present disclosure.

FIG. 9 is a flowchart of a method of translating regulatory requirements into a DSL according to an embodiment of the present disclosure.

FIG. 10 is a flowchart of a method of translating regulatory requirements into a DSL according to another embodiment of the present disclosure.

FIG. 11A is a flowchart of a method of translating regulatory requirements into process documents according to an embodiment of the disclosure.

FIG. 11B is a continued flowchart of the method of FIG. 11A.

FIG. 12 is a flowchart of a method of automatically authoring quality management documents according to an embodiment of the disclosure.

FIG. 13 is a diagram of an automated system for authoring quality management documents and managing regulatory requirements according to an embodiment.

FIG. 14 is an illustration of a user interface showing classification of sections of a regulatory document.

FIG. 15 is an illustration of a user interface showing assignment of properties to a section of a regulatory document.

The drawing figures are not necessarily drawn to scale, but instead are drawn to provide a better understanding of the system and associated steps, and are not intended to be limiting in scope, but to provide exemplary illustrations. The figures illustrate exemplary configurations of an automated system for authoring quality management documents and managing regulatory requirements, and in no way limit the configuration or use of systems for authoring quality management documents and/or managing regulatory requirements according to the present disclosure.

### DETAILED DESCRIPTION

Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

### Various Embodiments and Uses Thereof

Embodiments of the present disclosure advantageously provide an automated system for authoring quality management documents and managing regulatory requirements in any suitable field, such as field regulated by one or more government agencies, trade associations, or other organizations, in such fields as medical devices, in-vitro diagnostics, pharmaceutical research, aviation, banking and finance, environmental protection, and others. The automated system embodiments advantageously allow any organization, such as a manufacturer of regulated devices, to create custom-made Quality Manuals as required to comply with pertinent regulations, as well as an improved method for assessing compliance with processes spelled out in the Quality Manuals.

The automated system embodiments support and are configured to cooperate with a novel and improved domain-specific language (DSL) facilitating the conversion of pertinent regulatory and/or statutory requirements into the DSL, adding meta information to the DSL, and creating templates. The DSL may be a computer language specialized to the domain of storing regulatory requirements such that the legal meaning of said regulatory requirements can be understood and applied by a specialized computer. Whereas regulatory and statutory requirements are written in a language that only humans can understand, the automated system is configured to translate one or more pertinent legal standards into the DSL such that regulatory documents, including Quality Manuals, can be automatically generated and managed by the automated system.

The automated system embodiments advantageously mitigate the need for a manufacturer or user to author a Quality Manual from scratch, to complete onerous coding for each component of a particular regulatory requirement, or to do extensive reworks to a custom Quality Manual and associated Process Documents upon changes or updates to the regulatory requirements.

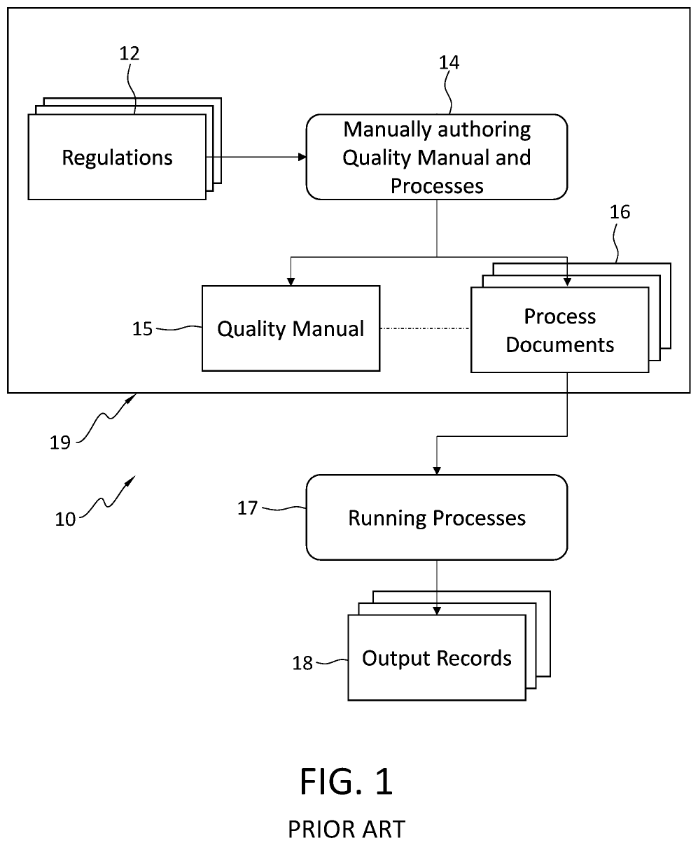

As described above, the existing and accepted approach for authoring Quality Manuals and related processes is shown regarding the method 10 of FIG. 1. Regulations 12 must be manually interpreted so as to manually author 14 a Quality Manual 15, which defines or comprises an overview document referencing all relevant processes, and associated Processes taking the form of Process Documents 16. The Processes are run 17 by the manufacturer and output records 18 are manually generated.

The output records 18 are signed, versioned documents that prove adherence by a manufacturer to the processes 16. This method is costly and time intensive as it requires the skill and effort of experienced and specialized persons at each stage to determine the relevance of regulations and to understand and apply the specific details of the market and products relating to the manufacturer. The services of such persons are acquired at great cost to a manufacturer. Most companies tend to follow industry best practices to simplify the process of demonstrating adherence to regulations. As such, any manufacturer that takes an innovative approach or process incurs additional costs to demonstrate their adherence to notified bodies, i.e. the pertinent regulatory authorities.

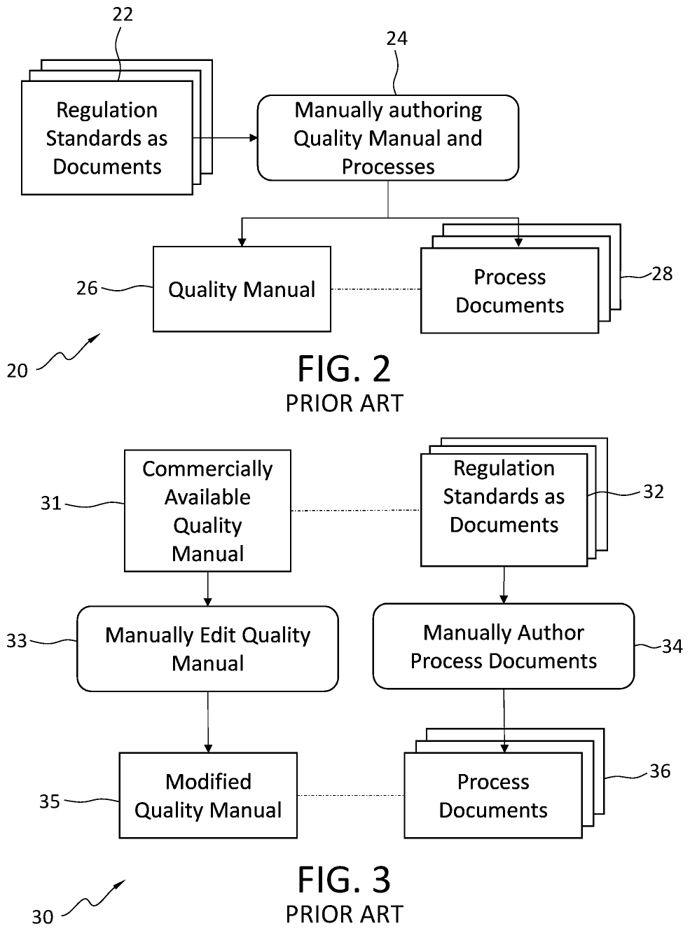

FIG. 2 shows a method 20 according to the section 19 of the method 10 shown and described regarding FIG. 1. The method 20 shows the basic approach currently used by manufacturers and other firms subject to regulatory requirements. The method 20 includes the steps of manually authoring 24 a Quality Manual 26 and related Process Documents 28 based on regulation standards 22. As discussed above, the method 20 is expensive, time-consuming, and inflexible to changes in the regulation standards 22, the manufacturer's product or production methods, or the market for the product.

FIG. 3 shows a method 30 used by some firms as an alternative to the method 20 of FIG. 2, involving the use of commercially available Quality Manuals 31. The commercially available Quality Manual 31 may be specific to a particular field, such as medical device manufacturing, and tailored to one or more prominent regulations pertaining to that field. In the case of medical device manufacturing, the Quality Manual 31 may be compatible with Regulation Standards 32 such as 21 C.F.R. 820 in the U.S. and MDR for the European Union.

Commercially available Quality Manuals 31 tend to cover all requirements of a particular regulatory environment, such that the manufacturer or user who purchases the Quality Manual 31 must manually edit 33 the Quality Manual 31 to remove inapplicable sections. The manufacturer or user must also manually author 34 process documents 36 from the regulation standards 32. The step of manually editing 33 the Quality Manual 31 includes the step of referencing the manually authored process documents 36 in the commercially available Quality Manual 31. The results of the steps of manually editing 33 the commercially available Quality Manual 31 and manually authoring 34 process documents result in a modified Quality Manual 35 and accompanying Process Documents 36. This method 30, like the methods 10 and 20, requires significant cost and time investment by a manufacturer for each product and market change.

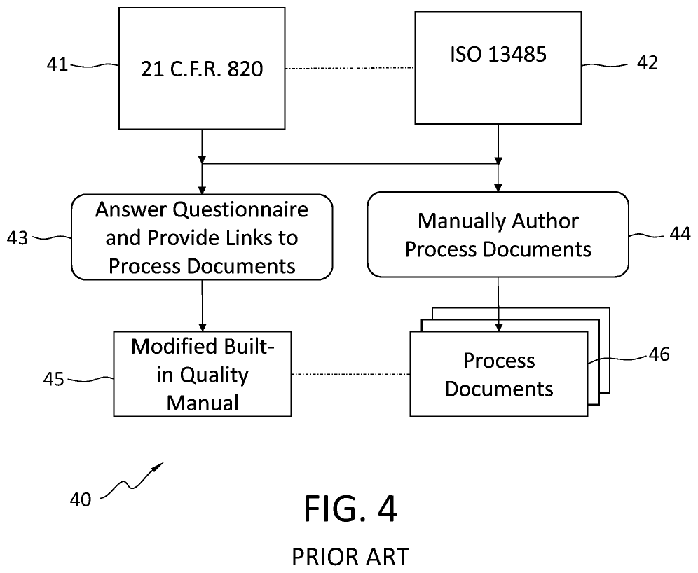

FIG. 4 shows an existing method 40 for producing a Quality Manual based on regulations, such as 21 C.F.R. 820 41 and ISO 13485 (a precursor to the MDR) 42. The method 40 may include manually authoring process documents 44 and using a software package to answer a questionnaire and provide links to the Process Documents 43. The software package may have a built-in commercially available Quality Manual that is edited based on the questionnaire answers and links. The step of providing links to the Process Documents includes providing reference names for the processes. The end result is a modified Quality Manual 45 and Process Documents 46. This method 40 may be used to provide a gap analysis for the manufacturer by listing processes required by the Quality Manual 45 for which references/links have not been provided by the manufacturer or user.

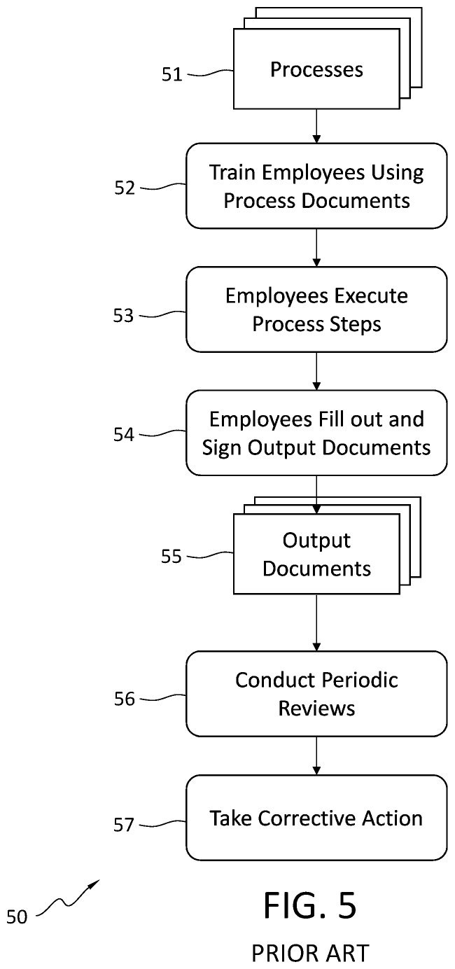

FIG. 5 shows an existing paper-based method 50 for running processes. After a Quality Manual and associated Processes have been manually authored, a manufacturer must prove the regulatory authorities that the processes are being run properly and in accordance with the pertinent regulations. The existing paper-based method 50 that is used by manufacturers today includes processes 51, which take the form of process documents. The process documents 51 are the source of truth regarding how to comply with regulatory requirements. Based on and using the processes 51 relevant to their particular roles, employees are trained 52. The employees then execute the process steps 53 manually, using the processes 51 as inputs.

To demonstrate that the processes 51 have been carried out properly, the employees fill out and sign 54 output documents 55. The output documents 55 form a record that can be reviewed to check whether the processes 51 have been adhered to. Periodic reviews are conducted 56 of the output documents 55. In the event that the periodic review ascertains that one or more processes 51 was not correctly performed, corrective action is taken 57. Often, the corrective action entails retraining the relevant employees, i.e. repeating step 52.

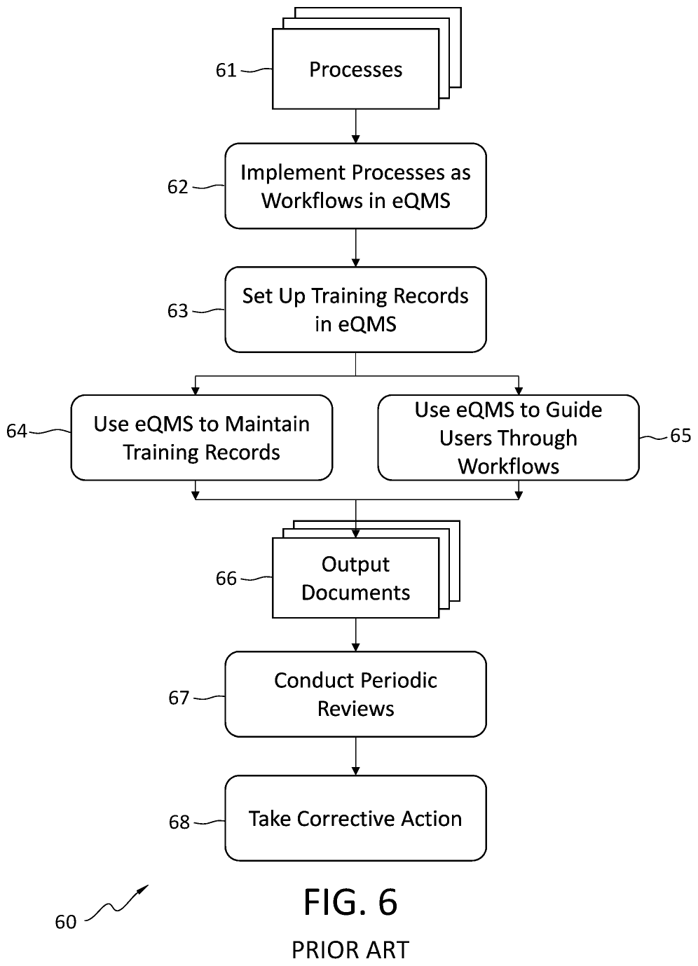

FIG. 6 shows an existing method 60 in which a software package known as an Electronic Quality Management System (eQMS) is used to track compliance with regulatory requirements. In method 60, the processes 61, which may take the form of process documents, the text of which manufacturers or users using the eQMS must translate or implement 62 into user-defined and user-specific workflows in the eQMS. The step 62 of implementing workflows from the processes 61 is complex and time-consuming and must be validated thoroughly to ensure that the workflow in the eQMS truly matches the text descriptions in the processes 61.

Because the eQMS does not actually understand the processes 61, an additional step 63 of setting up training records in the eQMS is required. This is complicated by the fact that not all eQMS systems support training. The eQMS can then be used to maintain training records 64 and to guide users, such as employees, through the defined workflows 65. As with the method 50, the method 60 includes producing output documents 66 based on the output records for a process that is being executed, which must be reviewed periodically 67 to ensure compliance. As described in greater detail below, a template may be created for each of the output records, the template including dynamic fields for which values may be derived from the process being executed. For example, a user executing a process may be prompted for filed values as part of running the process and/or users in relevant roles may be prompted to sign output documents created by the system by replacing the dynamic fields of the document templates with actual values from the process execution. To the extent that non-compliance is discovered, corrective action is taken 68. The periodic reviews 67 remain indispensable for the method 60 as the eQMS does not capture interdependencies between distinct processes 61, making the entire method 60 subject to error.

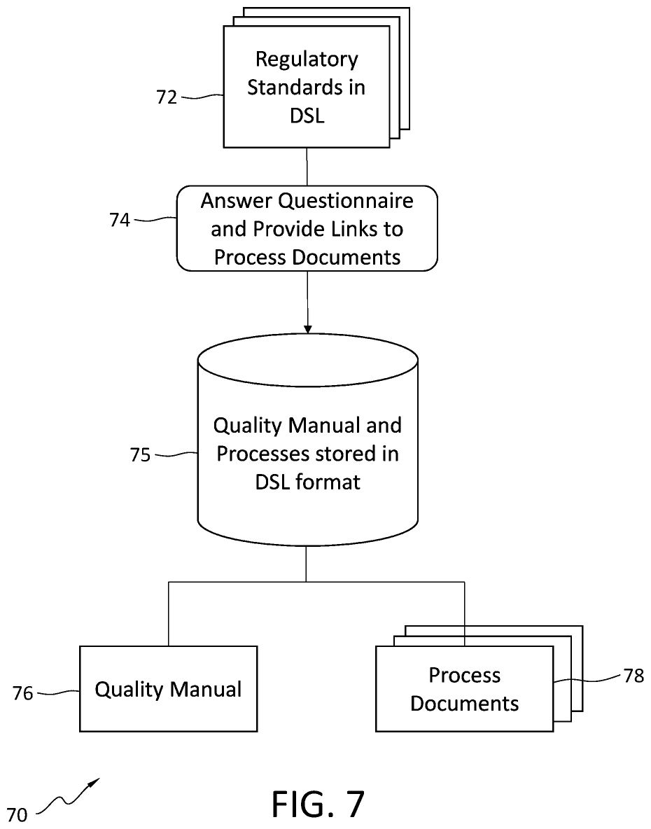

FIG. 7 shows a flowchart of a method 70 according to an automated system embodiment of the present disclosure. The method 70 and the automated system for performing the method 70 advantageously address the drawbacks of existing approaches, such as those described in FIGS. 1-6, for adhering to regulatory requirements. The method 70 is based on and cooperates with regulatory standards 72. The regulatory standards 72 and pertinent processes are advantageously interpreted using a set of rules and stored on the system in a domain-specific language (DSL) understandable to the system, as will be described in greater detail herein.

The method 70 includes the system using the regulatory standards 72 embodied in the DSL to provide end users with a tailored quality management system that includes relevant process. Step 74 includes retrieving information from the manufacturer or user through a questionnaire. In an embodiment, the system may recognize from the information input by the manufacturer or the user what kind of operator the organization is, which requirements from the regulatory standards 72 embodied in the DSL are applicable to the organization, and a mapping between roles in the organization and roles listed in applicable process templates. The information can then be used to automatically author both a Quality Manual and associated Process Documents for the organization, containing only the processes for applicable requirements and listing organization-specific roles mapped to corresponding process-template roles. This advantageously reduces the cost, complexity, and time-intensity of manually authoring Quality Manuals and associated Process Documents, as shown and described regarding FIGS. 1-6. The automatically authored Quality Manual and Process Documents can be stored 75 on the system in the DSL.

In a final step of the method 70, the system may output the automatically generated Quality Manual 76 and the associated Process Documents 78 from the DSL format as readable documents. The use of an automated system according to the embodiments including and cooperating with a DSL that allows for the interpretation of regulatory standards advantageously allows for a manufacturer or user to generate a Quality Manual and Process Documents with significantly reduced cost and time investment.

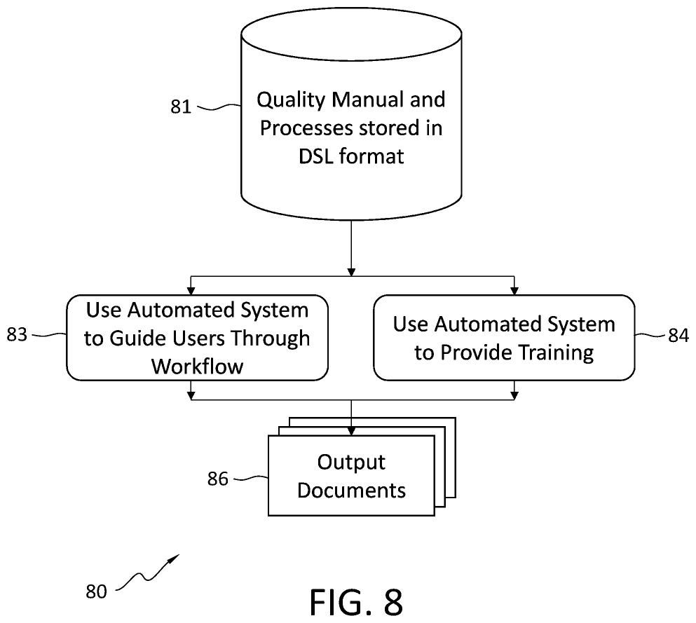

Likewise, a method 80 shown in FIG. 8 utilizes the automated system to automatically author a Quality Manual and associated Processes and store 81 these documents in the DSL. These documents, which are the outputs of the method 70, are used by the system to guide users through pertinent workflows 83 and/or to provide training 84. Because the inputs—the Quality Manual and the associated Processes—are already stored in the DSL, there is no need for the manufacturer or user to manually convert the human-readable Process Documents to eQMS workflows as is done in existing methods, such as the method 60. Rather, the steps 83 and 84 of guiding users through the workflow and providing training can be done automatically using the DSL-translated Process Documents and Quality Manual in order to produce the desired output documents 86 to ensure compliance.

For example, when employees of an organization are added as users, they may be given corresponding organizational roles, as described above. The system may then know which processes are applicable to each employee, meaning that the system can ensure that process actions are only performed by users in the correct roles. Further, the system can detect that a user, in a given role, is executing a process for the first time without training. In this situation, the system is configured to require the user to go through the corresponding training. The corresponding training may comprise having the user execute the required workflow using mock or sample data, after which the system may generate and validate a training report. In another example, at step 83 the system may ensure that any process is conducted by the correct employees and in the correct order.

Workflows according to embodiments of the current disclosure may contain input dependencies, outputs, roles questions, record templates, process descriptions, etc. A workflow may be triggered when any of its corresponding inputs are changed. Accordingly, it will be indicated to a user that inputs to the workflow have changed and steps are required to complete or continue the workflow, such as by answering questions set out in the workflow, filling in and/or generating any record templates required by the workflow, and/or following the related process description. The workflow description may include a set of defined outputs which, when updated, will trigger other workflows where the output is the input to that procedure. At a minimum, changes to outputs may trigger review processes of affected workflows, advantageously ensuring automatically that all outputs are reviewed and signed as appropriate.

In one example according to article 22.3-1 of the MDR, two workflows are provided which are activated if the device being developed, manufactured, or serviced requires sterilization. A first workflow may then be activated if the device description changes and the description newly includes sterilization. This will trigger the workflow to generate sterilization instructions. The workflow will additionally include a record template required for the sterilization instructions and a process description to generate the instructions based on Annex 9 or Annex 11 Part A. The output from the workflow would be sterilization instructions, which must be reviewed and signed based on process roles when updated. Following signing of the instructions, other workflows may be triggered such as risk analysis, etc. A second workflow may be dependent on a manufacturing batch and may be activated if the device requires sterilization, such that an individual assigned to an appropriate role is required to issue a statement declaring that the manufacturing was done in accordance with the sterilization instructions. The system may also include capabilities for validation and verification testing; however, the DSL and generated output documents will be dependent on the corresponding regulatory requirements. For example, the European medical standard MDR may not explicitly mention verification and validation testing that needs to be done as related to software testing; however, the system may store the best practices related to this process as DSL code 93 and may add validation and verification testing to output documents 86.

Additionally, the system may include capabilities related to auditing regulatory processes. The system may define operators in the DSL, wherein an operator is an economic entity mentioned in a regulatory standard. Such an entity may be manufactures and notified bodies, wherein notified bodies are responsible for auditing the manufacturers. Thus, a notified body and manufacturer may use the system to implement a regulatory standard; however, the system may produce a different set of workflows or templates for the notified bodies than the manufacturers.

The system may further be configured to conduct any regulation-required reviews. The system and method of embodiments of the present disclosure advantageously mitigate the need for the reviewer to ensure that the correct processes were performed by the correct employees in the correct order, as this is automatically performed by step 83. The reviewer need only ensure whether the content provided by the employees is correct, for example an employee-entered risk assessment for a feature in a hazard analysis review.

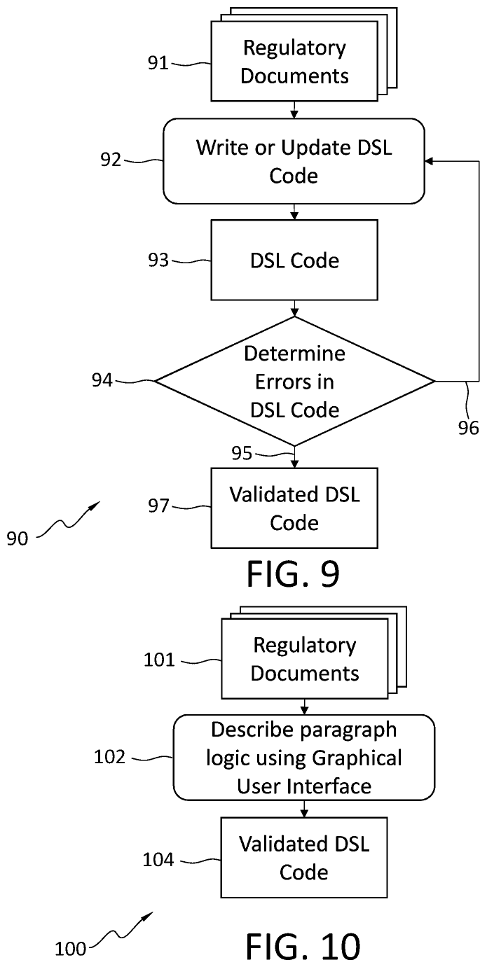

The translation of regulatory information into the system is shown and described regarding FIGS. 9 and 10. A method 90 pertains to regulatory documents 91, such as specific paragraphs of applicable regulations which represent a requirement of the manufacturer or user. In the case of medical device manufacturers, this may include, for example, at least portions of 21 C.F.R. 820 and/or the MDR. The regulatory documents 91 are, by definition, human readable, but are not understandable to an automated system. At step 92, one or more requirements of one or more regulations described in the regulatory documents 91 is translated into the DSL of the system, resulting in DSL code 93. The regulatory documents 91 may include multiple regulatory requirements from different jurisdictions into one simplified DSL code 93. This is beneficial to manufacturers that desire to comply with regulatory requirements in multiple jurisdictions, as end users are often required to adhere to multiple region-based standards.

Translation according to the current disclosure embodies transforming a regulatory text into building blocks according to a specified set of rules that determine the nature of the building blocks and that thereby allows for the automatic translation of an entire class of regulatory texts. Building blocks of a regulatory text may include processes, roles, conditions, operators, etc., and due to embodiments of the system breaking up the regulatory text into DSL code 93, the system may run on the basis of those building blocks. Accordingly, from an initial set of building blocks the current system may be extended to support entire classes of regulatory texts having similar building blocks, such classes of regulatory texts including medical device manufacturing, pharmaceuticals, aviation, education, energy development, banking, broadcasting, agriculture, water resources, automobiles, infrastructure, food safety, mineral and resource development, telecommunication, and others.

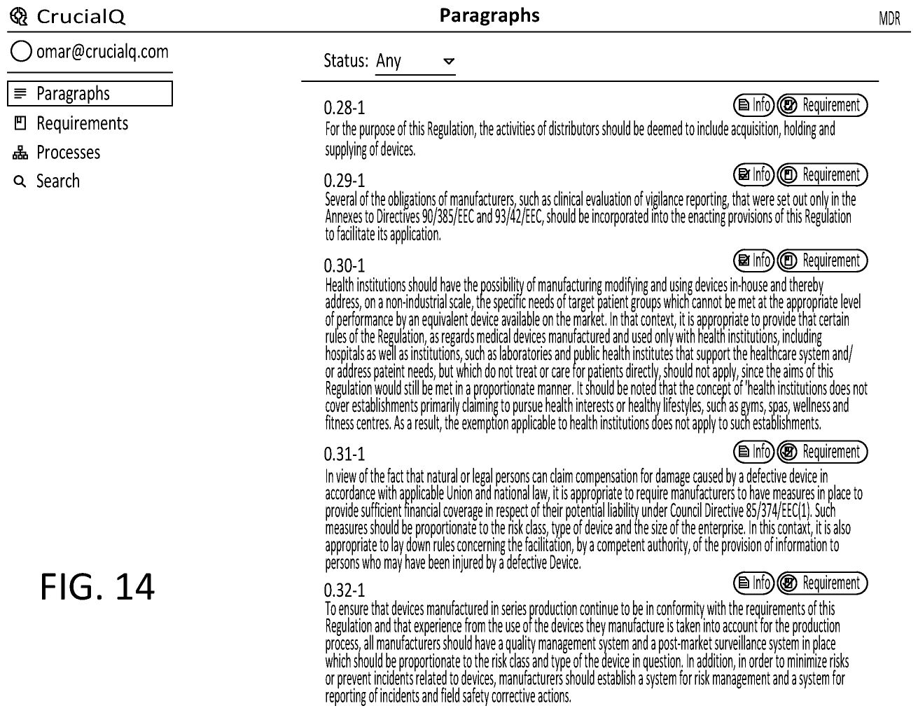

Translation of the one or more requirements of one or more regulations described in the regulatory documents 91 into the DSL of the system may include importing a regulatory text into a standard set for conversion to DSL code 93. The DSL code 93 represents the logic in the one or more requirements of the one or more regulations described in the regulatory documents 91. The standard set may be portioned into sections, such that each section may be classified as one of a requirement or information (non-requirement), for example in the manner illustrated by the user interface of FIG. 14. In one example, the sections may be defined by individual paragraphs, sentences or in another manner as would be understood by one skilled in the art informed by the present description.

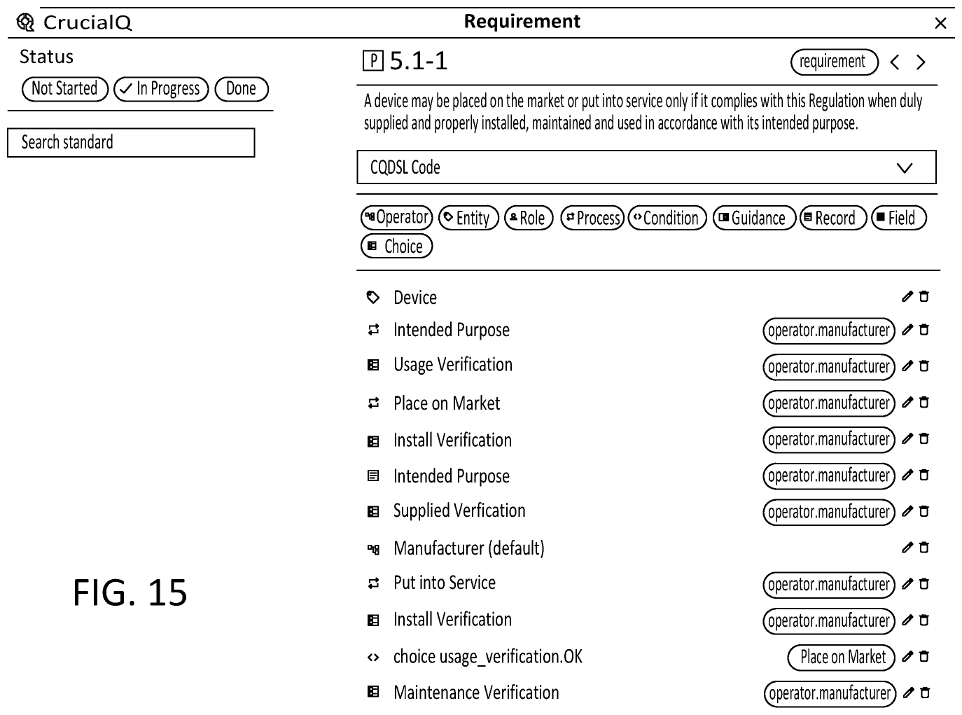

Each section of the standard set that is classified as a requirement may be assigned properties in the DSL code 93. The assigned properties may include adding questionnaires, records and processes as well as listing an operator that the requirement applies to, for example in the manner illustrated by the user interface of FIG. 15. For instance, standards such as the MDR have requirements for different operators including manufacturers, distributors, etc., and by connecting requirements to operators a filter condition may be established that can be applied to the manufacturer or the user (i.e. if an end user organization is only a distributor, manufacturer requirements that are not applicable may be excluded).

According to embodiments, the assigned properties for each section of the standard set that is classified as a requirement may be used as rules for automatically arranging all required processes in a memory and/or in a graphical representation such as in a flowchart or other diagram form. For this purpose, the system may review input records, output records, questions and answers associated with each process to identify dependencies of the process. For example, the dependencies may be used to automatically derive whether a process A depends on a process B and, if any of the input records to B are output records from A, then B would follow A, such as in a flowchart diagram or other representation. Other input records, output records, questions and answers may be used to form decision nodes in the system, such that the system may automatically determine what processes are applicable for a given user based on the user's responses.

In some embodiments, the system may further group related questions, input records, output records, or processes together so that only relevant requirements are presented to the user. In like manner, the system may attach document templates to associated sections of the standard set that are classified as requirements or to associated processes. The document templates may be automatically derived based on the requirement itself, including for example a list of fields that a record should contain and/or information from sections of the standard set that are classified as information for a given requirement. The templates may contain high level process instructions that list the actions to be taken and the roles responsible, such that responsible roles may be assigned to the actions to be taken and mapped to actual roles in end-user organizations in response to user inputs. The templates may be customized by a user to create a layout, arrange required fields, and add placeholders for headers, signature lines, and the like.

At step 94, a compiler of the system determines whether there are errors in the code. For example, errors may be gaps in dependencies between requirements and/or missing input records, output records, questions, answers, etc. If there are errors 96, the compiler indicates where the errors in the DSL are, and the DSL code can be updated at step 92. If there are no identified errors 95, the DSL code 97 is validated. The compiler may be any suitable compiler, such as a cross-compiler, a bootstrap compiler, a decompiler, a transcompiler, a one-pass or multi-pass compiler, or otherwise. The compiler may be configured to receive, for example, the DSL and to determine compilation errors due to errors in the DSL code.

The method 100 according to FIG. 10 similarly pertains to regulatory documents 101. At a step 102, a graphical user interface (GUI) 102 of the system is used to describe the paragraph logic, such as in the form of a flowchart or other diagram as described above, with the system automatically generating valid DSL code 104 from the descriptions of each section of the standard set. The GUI at step 102 is used to create corresponding entities of the regulatory documents 101 that can ultimately be converted to a validated DSL code 104. Whereas in existing eQMS approaches, the cost is driven up by the need for the services of an individual who has expertise in not only the legal and regulatory requirements but also in programming, the method 100 advantageously allows for an individual with only legal and regulatory experience to produce valid DSL code. The proposed system and method provide an easier way for individuals with relevant regulatory experience to convert regulatory documents to DSL and offers a no-code development platform as a GUI.

The GUI at step 102 may be used to add document definitions as DSL elements. This may be applicable when regulatory documents 101 discuss certain required documents and document fields that must be kept. The GUI at step 102 may be used to add action definitions and specify which actions are to be performed by specific operators. The GUI at step 102 may be used to add conditions to specify when a sections of regulatory documents 101 are applicable. These conditions may have sophisticated ‘AND/OR’ logic and can be used to automatically construct questionnaires that allow the final validated DSL code 104 to recognize which sections apply to specific users. The GUI at step 102 may be used to define dependencies between actions, records, conditions, users, and the like. Finally, the GUI at step 102 may provide a validator to validate DSL logic and indicate if and where there are problems. These problems may include circular conditions, paragraphs not being covered, records not being created by actions, actions where responsibility is unassigned, and the like.

For instance, the step 102 may interpret a requirement, such as MDR-0.35, and convert the requirement into the DSL. MDR-0.35 reads: “For manufacturers who are not established in the Union, the authorized representative plays a pivotal role in ensuring the compliance of the devices produced by those manufacturers and in serving as their contact person established in the Union. Given that pivotal role, for the purposes of enforcement it is appropriate to make the authorized representative legally liable for defective devices in the event that a manufacturer established outside the Union has not complied with its general obligations. The liability of the authorized representative provided for in this Regulation is without prejudice to the provisions of Directive 85/374/EEC, and accordingly the authorized representative should be jointly and severally liable with the importer and the manufacturer. The tasks of an authorized representative should be defined in a written mandate. Considering the role of authorized representatives, the minimum requirements they should meet should be clearly defined, including the requirement of having available a person who fulfils minimum conditions of qualification which should be similar to those for a manufacturer's person responsible for regulatory compliance.”

The corresponding DSL code may read:

Manufacturer: IsDefault( )

This code lists processes that need to exist within an organization. For each process listed, there must be an organization responsible. The code Manufacturer: IsDefault( ) states that in cases where a process is defined without defining a responsible organization, the responsible organization will default to Manufacturer.

Initialize.Providelnformation( )->Information.OutsideEU? (Yes, No)

This process requires a manufacturer to answer a binary question regarding whether the process is outside the EU.

Initialize.Providelnformation( )->Information. Comply WithGeneralEUObligations? (Yes, No)

When(Information.OutsideEU?.Yes AND Information.ComplyWithGeneralObligations?.No) Initialize.ProvideInformation.AuthorizedRepresentative( )

If the manufacturer has answered yes to the question OutsideEU and No to the Comply WithGeneralObligations question, the manufacturer must run the AuthorizedRepresentative process.

“Initialize.ProvideInformation.AuthorizedRepresentative( )” when used herein, defines a process having the name AuthorizedRepresentative, and serves to group together relevant processes and information and ensure the uniqueness of each name.

Initialize.ProvideInformation.AuthorizedRepresentative( )->Device:Information.AuthorizedRepresentative.Mandate

The output of the AuthorizedRepresentative process is a record document called Mandate (represented as “Information.AuthorizedRepresentative.Mandate”) which is related to a specific type of device. If and when an authorized representative represents multiple types of devices, there is a Mandate document for each type.

Initialize.ProvideInformation.AuthorizedRepresentative( ) Regulation(Directive:85/374/EEC)->Device:Information.AuthorizedRepresentative.LegalLiability.DefectiveDevices?(OK)

Initialize.ProvideInformation.AuthorizedRepresentative( )->Device.AuthorizedRepresentative.LegalLiability.JointLiabilityWithImporterAndManufacturer

Device:Information.AuthorizedRepresentative.Mandate<-Device:AuthorizedRepresentative.Role?

Device:Information.AuthorizedRepresentative.Mandate<-Device:AuthorizedRepresentative.MinimumRequirements?

The Mandate document includes a MinimumRequirements section.

Device:Information.AuthorizedRepresentative.Mandate<-Device:AuthorizedRepresentative.PersonAvailableWhichMeetsMinimumQualifications?

In addition to converting a requirement from a regulatory document, such as the MDR or 21 C.F.R. 820, which is written in human-readable text, as shown and described above, meta information may be added to process names, record/document names, section names, and other names. For example, Label(Information.OutsideEU?) may correspond to the question Are you located outside the EU?

Likewise, Label(Initialize.ProvideInformation.AuthorizedRepresentative( ) may correspond to the Authored Representative Process.

Label(Device:AuthorizedRepresentative.MinimumRequirements?) may correspond to the requirement for a manufacturer or user to provide the minimum requirements needed for the authorized representative. These requirements may be similar to the person responsible for compliance within your organization. Further information may be added for each process in the DSL to provide more detail as to which role within an organization is responsible for a particular process or part of a particular process.

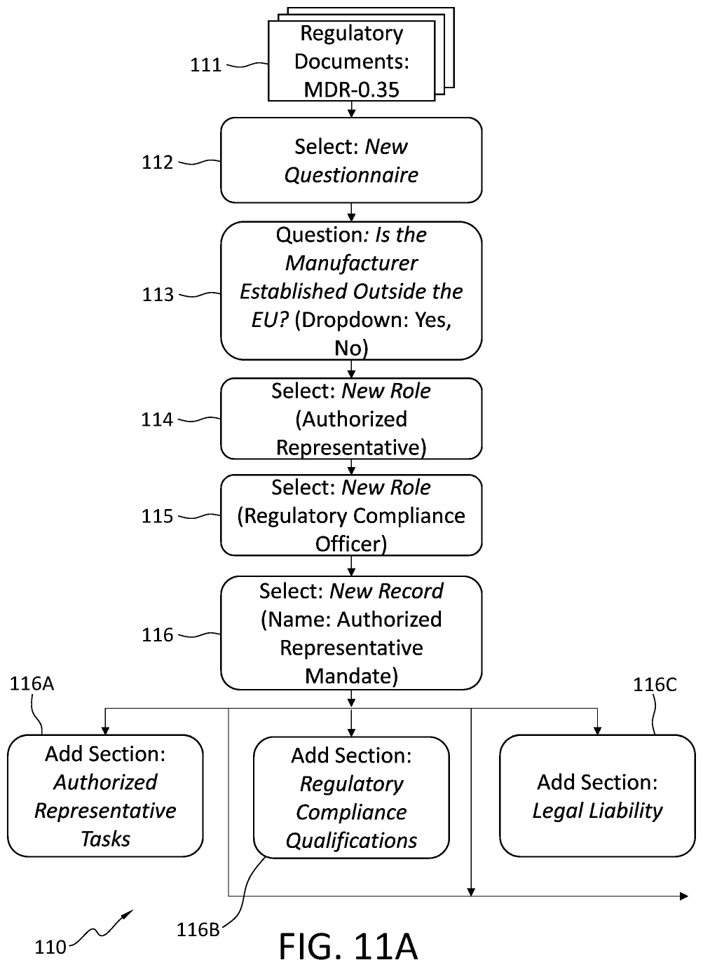

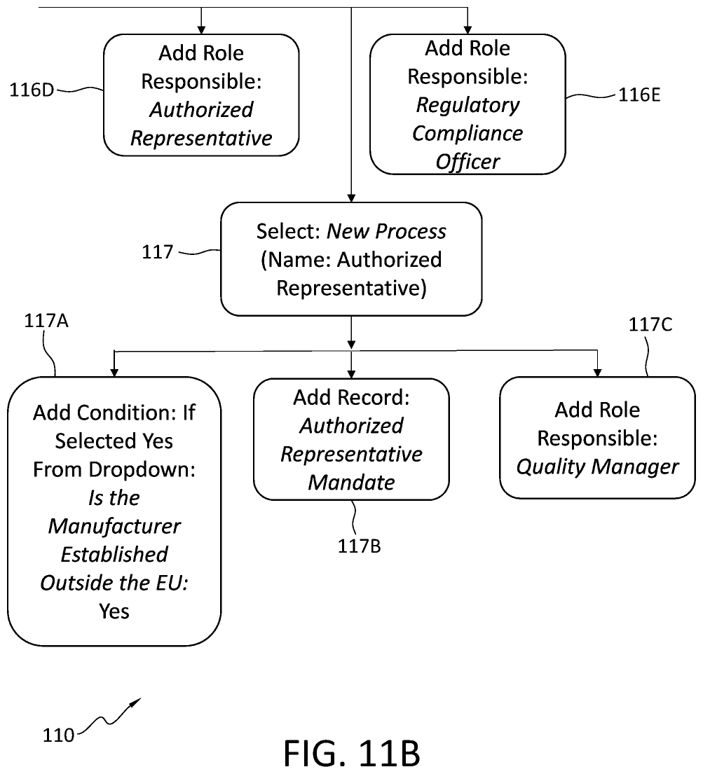

There may be several phases or procedures to convert the requirement of MDR-0.35 into the DSL code shown above at step 102 of the method 100 using the GUI, as described and shown regarding FIGS. 11A and 11B. A method 110 of converting a regulatory document 111, such as MDR-0.35, into the DSL of the system as shown above may include a first step 112 of selecting a new questionnaire. The questionnaire may inquire at 113 “Is the Manufacturer Established Outside the EU?” The manufacturer or user may answer in any suitable manner, such as using a dropdown menu, to answer yes or no. This may correspond to the above-mentioned DSL code Initialize.ProvideInformation( )->Information.OutsideEU? (Yes, No). Thus, based on the above-mentioned DSL code, the process identifies which questions manufacturer needs to answer, based on which standard(s) they need to comply with, and presents those questions to the manufacturer. Thus, the process identifies which parts of the above-mentioned DSL code are applicable.

The manufacturer or user may be prompted at 114 to select a New Role and prompted to fill in one or more details. For example, the user may be prompted to enter a Name, such as Authorized Representative. At 115, the user may be prompted to against select a New Role and to enter a Name, such as Regulatory Compliance Officer. The possible names, including Authorized Representative and Regulatory Compliance Officer, may be provided as options in a dropdown menu or in any suitable manner. After the system determines that the necessary roles have been entered, the system may prompt at 116 the manufacturer or user to select a New Record. The system may prompt the user to enter a Name, such as Authorized Representative Mandate, which may be selectable from a dropdown menu.

Within the New Record, the manufacturer or user may select Add Section 116A, 116B, 116C, and specify names such as Authorized Representative Tasks, Regulatory Compliance Qualifications, and Legal Liability, respectively. These may be selectable from a dropdown menu or any other suitable manner. Within the New Record, the manufacturer or user may further be prompted to select Add Role Responsible 116D, 116E and enter Authorized Representative and Regulatory Compliance Officer, respectively.

After the New Record 116 has been filled in, the system may prompt the manufacturer or user to select New Process 117 and to fill in information such as Name and/or to add Condition, Record, and/or Role Responsible. The Name may be Authorized Representative, and the Condition 117A may be when the Questionnaire “Is the Manufacturer Established Outside the EU” is answered Yes via the dropdown menu at step 113. The Record 117B may be the Authorized Representative Mandate. The Role Responsible 117C may be the Quality Manager.

The method 110 thus allows for an improved and simplified method for translating the human-readable text of a regulatory document to be translated stepwise into the DSL of an automated system for authoring quality management documents and managing regulatory requirements according to an embodiment of the disclosure. The requirements of MDR-0.35, as detailed above, can be entered into the DSL of the system such that the requirement that a medical-device manufacturer outside the EU can confirm to pertinent authorities that the required role of Authorized Representative has performed the tasks defined in a written mandate, including required tasks, qualifications, and details regarding legal liability. With this information entered through the method 110, the text of MDR-0.35 is translated into validated DSL code that can be used by the system to output a Quality Manual and associated Process Documents without the need for manually authoring the documents.

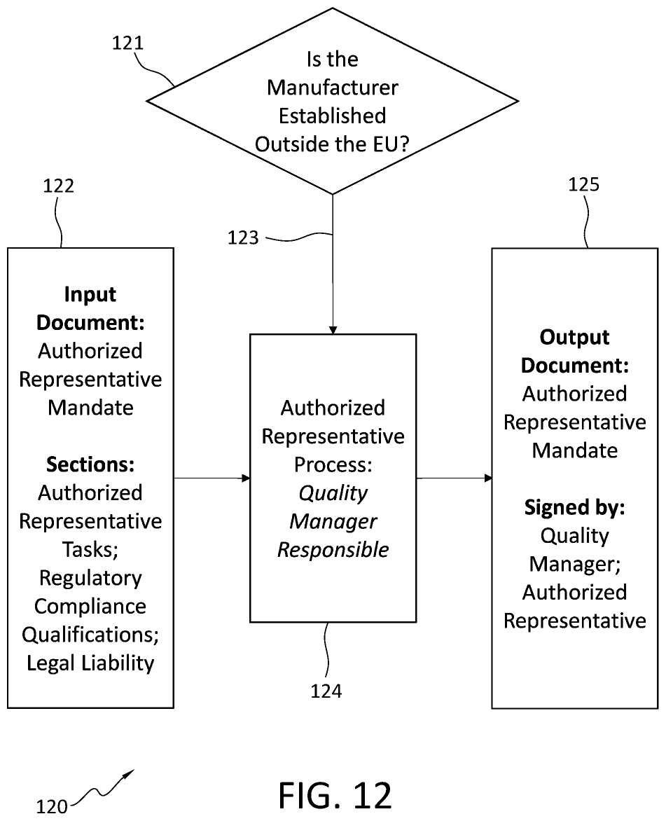

The information entered into the system using the method 110 is shown in the diagram 120 of FIG. 12, where upon determining at decision 121 that the Manufacturer is Established Outside the EU 123, and based on an Input Document at 122, which may be the Authorized Representative Mandate comprise sections detailing Authorized Representative Tasks, Regulatory Compliance Qualifications, and Legal Liability entered in the New Record, it is determined at 124 that the Quality Manager is responsible for the Authorized Representative Process, and an Output Document 125 of the Authorized Representative Mandate signed by the Quality Manager and Authorized Representative can be produced to verify compliance.

The system is configured to create templates for documents, such as the Authorized Representative Mandate document, represented in the DSL as Device:Information.AuthorizedRepresentative.Mandate. The DSL has defined which sections should be included in the document, and these sections may be left as placeholders, with the look and feel, headers, and general text added thereto.

Using the method 110 of FIGS. 11A and 11B, and building on the templates generated by the system, the system may ask the manufacturer or user through the questionnaire relevant questions from the DSL and construct a Quality Manual from the provided answers. For example, from the DSL code Information.OutsideEU? (Yes, No) the system may ask the manufacturer or user whether they are located outside the EU and present two possible answers that the manufacturer or user may select: Yes and No. If the manufacturer or user answers No, the When condition of the DSL code will not be satisfied, and the system can omit the Authorized Representative Process from the custom Quality Manual being automatically authored for the user. After the manufacturer has answered all necessary questions included in the questionnaire, based on the DSL and their answers, the method 110 may filter which requirements from the regulatory requirement are applicable to the manufacturer.

While the method 110 of FIGS. 11A and 11B for converting a regulatory requirement per MDR-0.35 into the DSL of embodiments has been shown and described, it will be appreciated that the method 110 may be applied to any regulatory requirement and is not limited to MDR-0.35 or to medical device manufacturing generally. Rather, the method 110 may be applied to any requirement and may include one or more of the steps of selecting a questionnaire, answering questions, selecting roles, selecting records, adding sections, adding roles responsible, selecting processes, adding conditions, adding records, combinations thereof, or any other suitable step.

The method 110 advantageously reduces the time and expertise required to convert human-readable regulatory text into computer-readable and -executable code by providing an interactive GUI that allows a regulatory employee, even one without knowledge of programming, to convert regulatory requirements into the DSL such that the automated system may automatically generate and author a pertinent regulatory document, such as a Quality Manual.

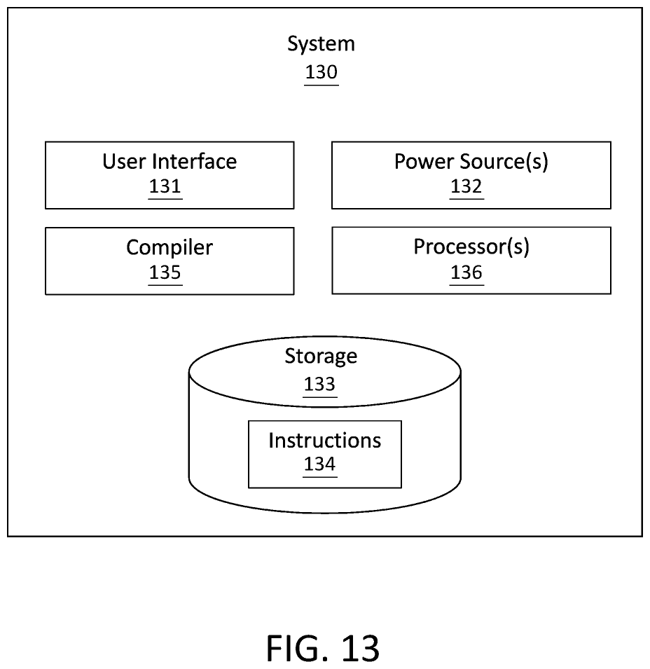

FIG. 13 is a diagram of a system 130 for automatically authoring and managing regulatory documents according to an embodiment of the disclosure. The system 130 may comprise a user interface 131, a power source 132, a processor 136, a compiler 135, and a storage 133 with instructions 134 stored thereon.

The storage 133 may comprise instructions 134 for operating an automated system and method for authoring quality management documents regulatory requirements stored thereon in a non-transitory form that, when executed by the processor 136, cause the processor 136 to carry out one or more of the steps described herein, in particular receiving regulatory documents and standards, converting text of the standards to DSL, and generating a custom Quality Manual and/or associated Process Documents. The storage 133 may further be configured to store the DSL code of the translated regulatory text and/or the generated Quality Manual and/or Process Documents.

Embodiments of the present disclosure may comprise or utilize a special-purpose or general-purpose computer system that includes computer hardware, such as, for example, one or more processors and system memory, as discussed in greater detail below. Embodiments within the scope of the present disclosure also include physical and other computer-readable media for carrying or storing computer-executable instructions and/or data structures.

Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the disclosure.

Transmission media can include a network and/or data links which can be used to carry program code in the form of computer-executable instructions or data structures, and which can be accessed by a general-purpose or special-purpose computer system. A “network” may be defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions may comprise, for example, instructions and data which, when executed by one or more processors, cause a general-purpose computer system, special-purpose computer system, or special-purpose processing device to perform a certain function or group of functions. Computer-executable instructions may be, for example, binaries, intermediate format instructions such as assembly language, or even source code.

The disclosure of the present application may be practiced in network computing environments with many types of computer system configurations, including, but not limited to, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

The disclosure of the present application may also be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

By providing an automated system and method for authoring quality management documents and managing regulatory requirements according to disclosed embodiments, the problem of existing approaches to complying with regulatory requirements, including costly, complex, and time-intensive manual and paper-based methods for authoring Quality Manuals and associated Processes, and tracking compliance therewith, are addressed. The disclosed embodiments advantageously provide an automated system and method configured to receive a human-readable regulatory text, convert the text to a novel and improved DSL, and utilize the DSL to obtain information from the manufacturer or user to build a custom regulatory document, such as a Quality Manual, with significantly reduced cost and complexity compared to existing approaches.

The system and method advantageously reduce the time-intensity of authoring quality management documents and managing the regulatory requirements as using the DSL of embodiments is an order of magnitude easier and less time-consuming than writing pure, novel software code to achieve the same result. The system and method embodiments according to the disclosure advantageously improve the functionality of a computer system on or in cooperation with which the automated system is carried out by reducing the length of code, reducing the work performed by the processor, and reduce the time required to author regulatory documents, such as Quality Manuals, and to implement regulatory documents, such as implementing training, workflows, and output records.

Not necessarily all such objects or advantages may be achieved under any embodiment of the disclosure. Those skilled in the art will recognize that the disclosure may be embodied or carried out to achieve or optimize one advantage or group of advantages as taught without achieving other objects or advantages as taught or suggested.

The skilled artisan will recognize the interchangeability of various components and steps from different embodiments described. Besides the variations described, other known equivalents for each feature can be mixed and matched by one of ordinary skill in this art to construct or use an automated system and method for authoring quality management documents and managing regulatory requirements under principles of the present disclosure. Therefore, the embodiments described may be adapted to regulatory requirements in general, including regulatory requirements across medical devices, pharmaceuticals, diagnostics, aviation, communication, environmental safety, and other fields.

Although the automated system for authoring quality management documents and managing regulatory requirements has been disclosed in certain preferred embodiments and examples, it nevertheless will be understood by those skilled in the art that the present disclosure extends beyond the disclosed embodiments to other alternative embodiments and/or uses of the automated system for authoring quality management documents and managing regulatory requirements and obvious modifications and equivalents. It is intended that the scope of the present automated system for authoring quality management documents and managing regulatory requirements disclosed should not be limited by the disclosed embodiments described above, but should be determined only by a fair reading of the claims that follow.

What is claimed is:

1. An automated system for authoring quality management documents and managing regulatory requirements, the system comprising:
a processor configured to receive text corresponding to the regulatory requirements, convert the text to a domain-specific language and produce a domain-specific language code;
a user interface configured to receive at least one answer from a user in response to at least one question to the user, the at least one question being provided by the automated system; and
at least one storage device configured to store the domain-specific language code and the at least one answer;
wherein the domain-specific language is a computer language specialized to a domain of storing regulatory requirements.

2. The automated system according to claim 1, wherein the processor is configured to automatically generate at least one document from the domain-specific language code and the at least one answer.

3. The automated system according to claim 2, wherein the at least one document includes a Quality Manual and/or at least one associated Process Document.

4. The automated system according to claim 3, wherein the Quality Manual and/or at least one associated Process Document contain only processes for corresponding regulatory requirements and list organization-specific roles mapped to corresponding process-template roles.

5. The automated system according to claim 2, wherein the processor is configured to define at least one workflow from the at least one document.

6. The automated system according to claim 2, wherein the processor is configured to administer training to at least one employee based on at the at least one document.

7. The automated system according to claim 2, wherein the processor is configured to determine if an employee is executing a process corresponding to the at least one document for a first time.

8. The automated system according to claim 7, wherein the processor is configured to provide training for the employee using sample data to execute a workflow for the process corresponding to the at least one document for a first time.

9. The automated system according to claim 5, wherein the processor is configured to generate at least one output document based on the workflow.

10. The automated system according to claim 1, further comprising at least one compiler to detect at least one compilation error in the domain-specific language code.

11. The automated system according to claim 10, wherein the at least one compiler is configured to locate the at least one compilation error in the domain-specific language code when the at least one compilation error in the domain-specific language code is detected.

12. The automated system according to claim 10, wherein the processor is configured to update the domain-specific language code, correct the at least one compilation error, and provide a validated domain specific-language code.

13. The automated system according to claim 1, wherein the user interface is configured to facilitate selection by the user of one or more of a questionnaire, a new role, a new record, a new section, a new role responsible, a new process, and a new condition.

14. The automated system according to claim 1, wherein the user interface is a graphical user interface configured to perform one or more of the following actions:
add document definitions as domain-specific language elements;
add action definitions and specify which actions are to be performed by specific operators;
add conditions to specify when sections of the regulatory documents are applicable;
define dependencies between actions, records, conditions, and users; and
provide a validator to validate logic related to the domain-specific language.

15. The automated system according to claim 2, wherein the processor is configured to automatically perform regulation-required reviews and verify that the process corresponding to the at least one document is performed by a proper employee and in a correct order.

16. A method for authoring quality management documents and managing regulatory requirements, the method comprising the steps:
providing an automated system comprising at least one storage device, a processor, and a user interface;
converting text of at least one regulatory requirement of the regulatory requirements to a domain-specific language and storing the domain-specific language code on the at least one storage device;
providing at least one question to a user;
receiving at least one answer from the user and storing the at least one answer in the domain-specific language on the at least one storage device;
generating at least one document from the domain-specific language code and/or the at least one answer.

17. The method according to claim 16, further comprising the steps of:
guiding a user through a workflow of the at least one document;
detecting through the processor that a user is performing the workflow for a first time;
training the user on the workflow using sample data; and
outputting a training report for the user.

18. The method according to claim 16, wherein the step of converting text of at least one regulatory requirement of the regulatory requirements to a domain-specific language includes the steps:
identifying the at least one regulatory requirement;
entering the text of the at least one regulatory requirement into the user interface as the domain-specific language; and
using a compiler to determine errors in the domain-specific language corresponding to the at least one regulatory requirement.

19. The method according to claim 16, wherein the step of converting text of at least one regulatory requirement of the regulatory requirements to a domain-specific language includes the steps:
identifying the at least one regulatory requirement; and
describing paragraph logic of the at least one regulatory requirement using a graphical user interface.

20. An automated system for authoring quality management documents and managing regulatory requirements, the system comprising:
a processor configured to receive text corresponding to the regulatory requirements, convert the text to a domain-specific language, and produce a domain-specific language code;
a user interface configured to receive at least one answer from a user in response to at least one question to the user, the at least one question being provided by the automated system;
at least one storage device configured to store the domain-specific language code and the at least one answer; and
a compiler configured to identify errors within the domain-specific language code.
